(19) United States
(12) Patent Application Publication
(10) Pub. No.: US 2025/0300293 A1
(43) Pub. Date: Sep. 25, 2025

(54) ELECTRIC VEHICLE BATTERY AS A DYNAMIC ABSORBER FOR RIDE COMFORT

(71) Applicant: FCA US LLC, Auburn Hills, MI (US)

(72) Inventors: Sundar Ram Chanduri, Rochester Hills, MI (US); Sohail Rana, Troy, MI (US); Jaspreet Kukreja, Rochester, MI (US); Yawar Jahanjir, Rochester Hills, MI (US); Emanuel Montes Cabrera, Ortonville, MI (US); Jason D. Briggs, Newburyport, MA (US); Kelvin J. Selwa, Bloomfield Hills, MI (US); Steven T. Miller, Goodrich, MI (US)

(21) Appl. No.: 18/613,970

(22) Filed: Mar. 22, 2024

(51) Int. Cl. H01M 50/249; B60K 1/04; B60L 3/00; H01M 50/218

(52) U.S. Cl. CPC H01M 50/249; B60K 1/04; B60L 3/0046; H01M 50/218; B60K 2001/0438; H01M 2220/20

(57) ABSTRACT

A vehicle includes a frame having a natural frequency, a battery and a battery housing having the battery disposed therein. A plurality of mounts is coupled to the battery housing to the frame. The plurality of mounts is tuned to attenuate the response of the frame.

### FIELD

The present disclosure relates to electric vehicles, and, more particularly to an electric vehicle using battery pack to improve ride comfort.

### BACKGROUND

This section provides background information related to the present disclosure which is not necessarily prior art.

Previous internal combustion engine vehicles leveraged the heavy internal combustion powertrain as a dynamic absorber for ride comfort. Electric vehicle drive motor mass is much lighter than previous internal combustion engines and therefore less effective to use as a dynamic absorber to meet ride comfort targets on body on frame vehicles. However, the response of the frame at the ride comfort frequencies may have increased amplitude due to other factors, such as modal alignment, tire changes, etc. The ride comfort frequency range is 5-25 Hz. By reducing the frame amplitude thereof in this range, ride comfort may be improved.

### SUMMARY

This section provides a general summary of the disclosure and is not a comprehensive disclosure of its full scope or all of its features.

The present system uses the battery pack mass to improve the ride comfort by dampening response in the ride comfort frequency range. The battery pack therefore acts as a large dynamic absorber for attenuating low frequency ride comfort response.

In one aspect of the disclosure, A vehicle includes a frame having a natural frequency, a battery pack having the battery disposed therein. A plurality of mounts couples the battery pack to the frame. The plurality of mounts is tuned to attenuate a ride comfort response of the frame.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a side view of a body-on-frame vehicle having a battery pack.

FIG. 2 is a flowchart of a method for attenuating ride comfort frequencies according to the present disclosure.

FIG. 3A is a perspective view of a battery pack mounting method using crossbeams.

FIG. 3B is a side view of the battery pack of FIG. 3A.

FIG. 3C is a top view of the battery pack of FIGS. 3A and 3B.

FIG. 4A is a perspective view of the battery pack relative to the frame.

FIG. 4B is a side view of the frame and battery pack of FIG. 4A.

FIG. 4C is a top view of the battery pack coupled to the frame.

FIG. 4D is an enlarged perspective view of the crossbeams mounted to the frame.

FIG. 4E is a side view of the crossbeams mounted to the frame of FIG. 4D using supports.

FIG. 4F is a top view of the beams supporting the battery pack.

FIG. 5A is a perspective view of the battery pack relative to the frame without the cross members.

FIG. 5B is a side view of the frame and battery pack of FIG. 5A.

FIG. 5C is a top view of the battery pack of FIG. 5A coupled to the frame.

FIG. 6 is a perspective view of an alternative battery pack with mounts extending from the bottom of the battery pack.

FIG. 7 is a graph of velocity versus frequency for a battery fixed in place and a battery acting as a dynamic absorber.

FIG. 8 is a block diagrammatic view of using tunable mounts to attenuate the ride comfort response.

FIG. 9 is a flowchart of a method of operating the system of FIG. 7.

Corresponding reference numerals indicate corresponding parts throughout the several views of the drawings.

### DETAILED DESCRIPTION

Example embodiments will now be described more fully with reference to the accompanying drawings.

Referring now to FIG. 1, a vehicle 10 has a frame 12 and a vehicle body 14 that is coupled to the frame 12. The vehicle 10 is therefore referred to as a body-on-frame vehicle. In this example, the vehicle 10 is an electric vehicle because a battery pack 16 is coupled to the frame 12.

Previous internal combustion engine vehicles leveraged the heavy internal combustion powertrain as a dynamic absorber for ride comfort. The concept of using the battery as a structural element as typically used in unibody vehicles may not always be effective enough to meet ride comfort targets on body on frame vehicles. Electric vehicle drive motor mass is much lighter than previous internal combustion engines and therefore less effective to use as a dynamic absorber for ride comfort.

The battery mass is a significant portion of the overall electrified vehicle mass and is typically rigidly mounted (or hard mounted) to the frame. This novel invention softly mounts the battery mass to the frame using rubber bushings, tuning the rigid body natural frequencies of the battery mass in the ride comfort frequency range (5-25 Hz). This invention therefore leverages the battery mass to act as a large dynamic absorber for attenuating low frequency ride comfort response. Unlike prior solutions this invention does not add additional structure or mass to address ride comfort problems. Instead, it leverages the existing mass of the battery to address ride comfort problems.

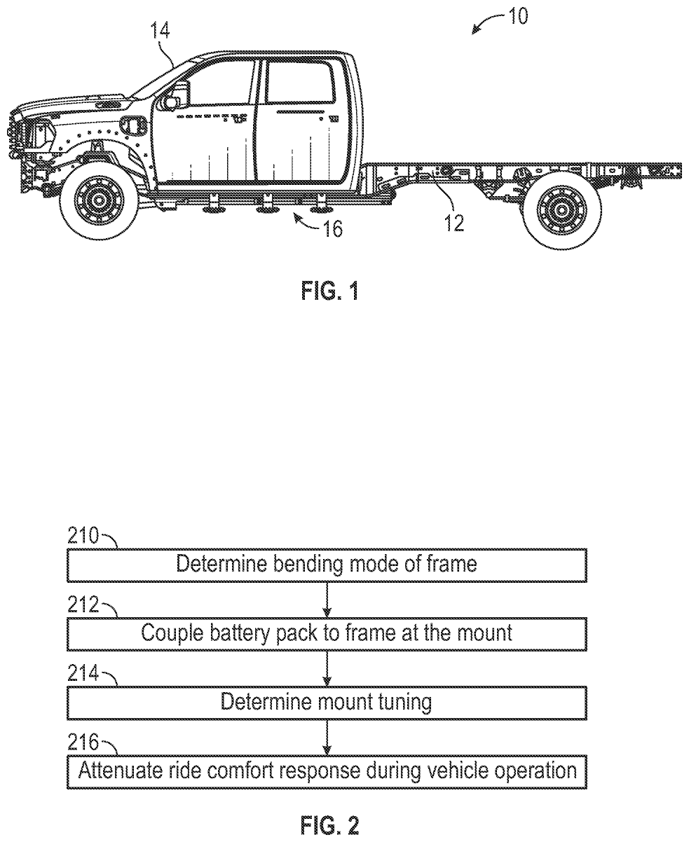

Referring now to FIG. 2, a method for improving the ride comfort of a vehicle 10 is set forth. In step 210, the bending mode of the frame in the vehicle is determined. The bending mode may be referred to as the frequency of the frame. The bending mode may be a natural frequency corresponding to a primary, secondary, or higher order bending mode. In step 212, the battery pack is coupled to the frame with the mount therebetween. In steps 214 and 216, these mounts may be tuned based on the bending mode of the frame, thereby attenuation of the ride comfort response during vehicle operation is achieved. Thereby, the battery pack is being utilized as a dynamic absorber. Bending frequency (or mode), equivalent stiffness of mounts and battery pack mass are related by the following formula:

$$ω = \sqrt{\frac{k}{m}}$$

$$ω = 2 * π * Bending Frequency$$

$$k = Equivalent Stiffness mounts$$

$$m = Battery Pack Mass$$

In one example, the battery pack mass=400 kg, the bending frequency=10 Hz, the equivalent stiffness of mounts=1580 N/mm, the dynamic stiffness of each battery mount (for a 10-mount architecture as illustrated)=158 N/mm.

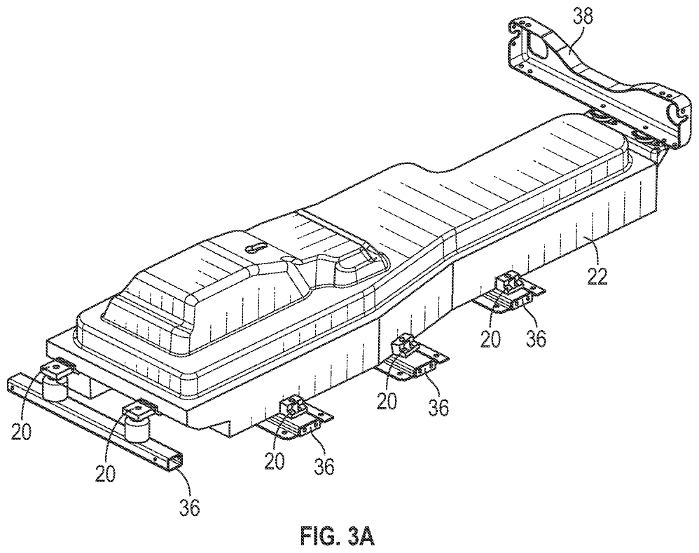

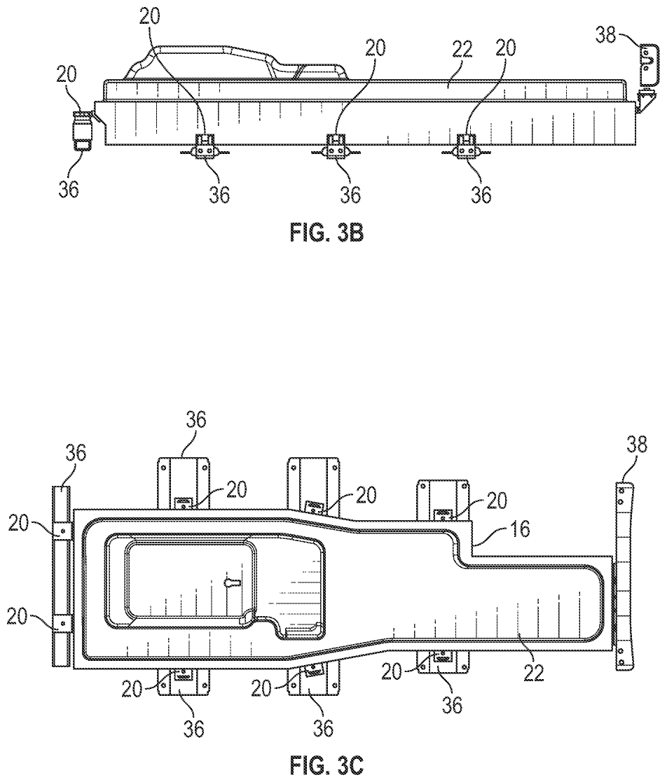

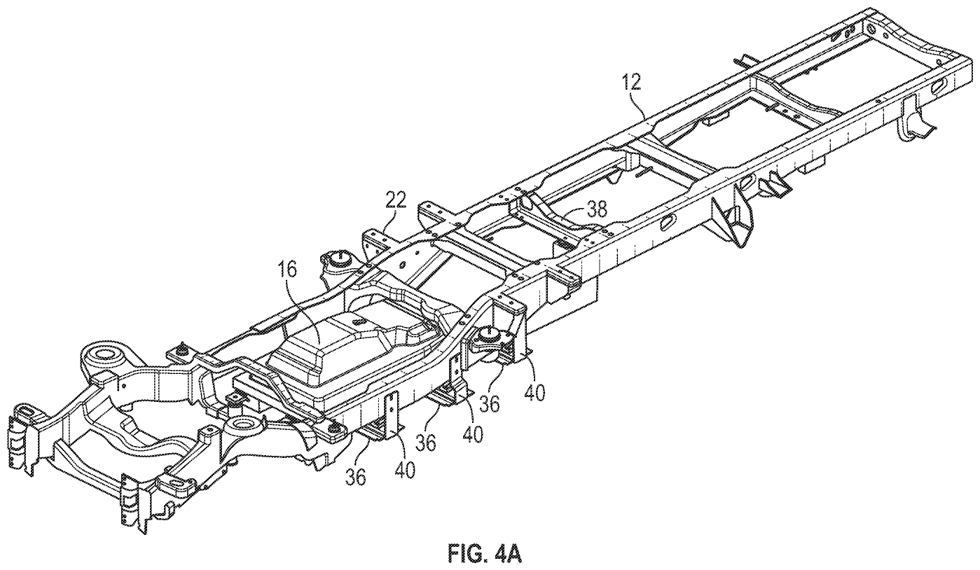

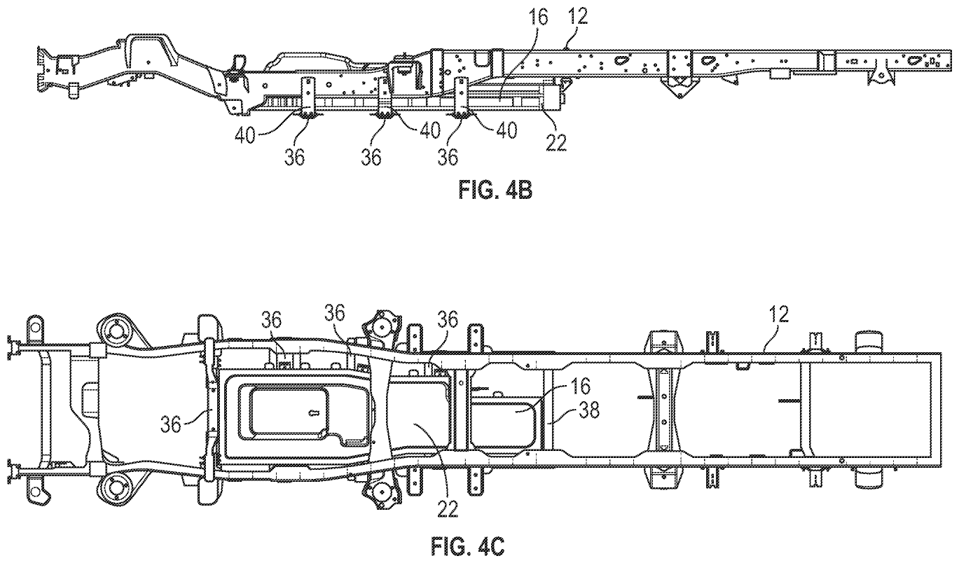

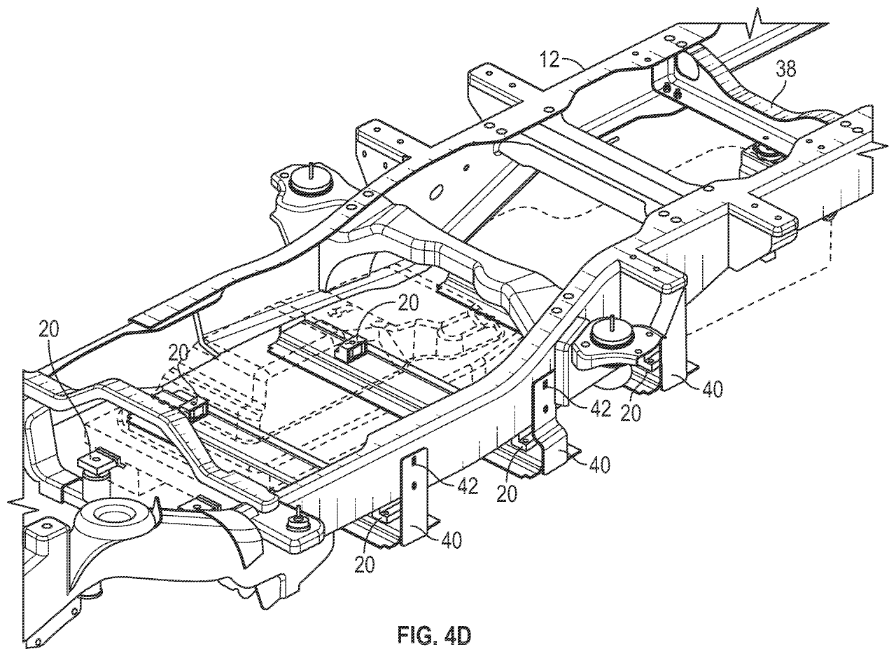

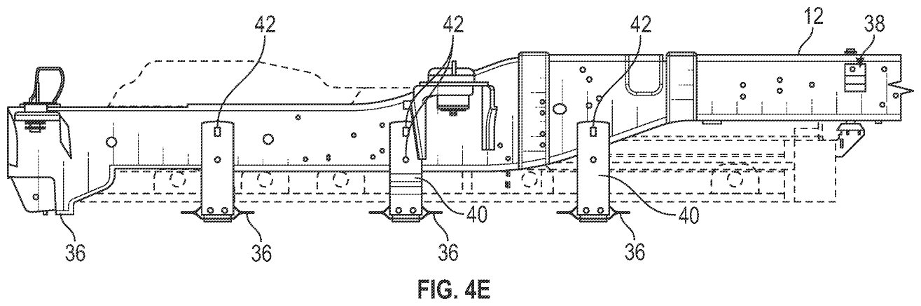

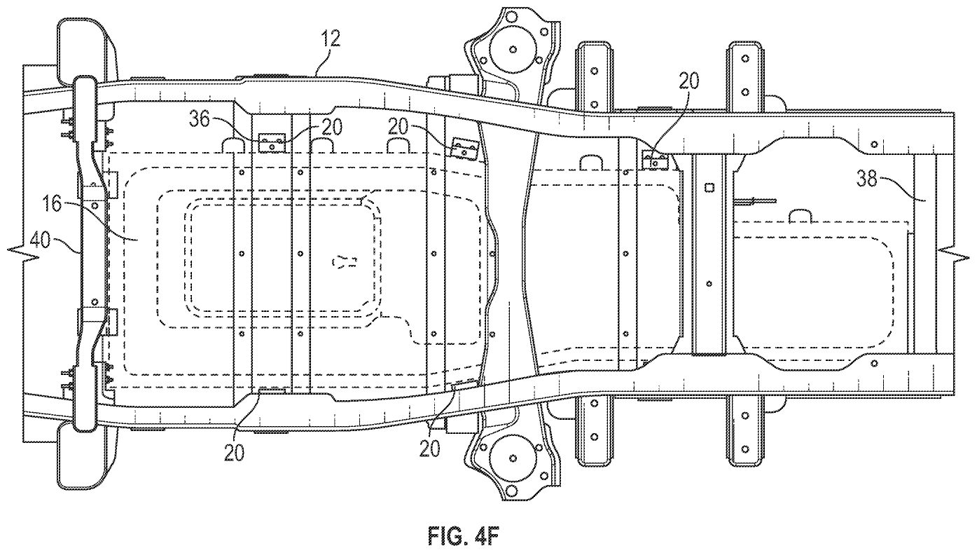

Referring now to FIGS. 3A-3C, the frame 12 (of FIG. 1 and as shown in FIGS. 4A-4F) has the battery pack 16 coupled thereto. The battery pack 16 has a plurality of mounts 20 coupled thereto. In the illustration of FIG. 3A-3C, ten mounts are provided. However, various number of mounts 20 depending upon the vehicle 10 and the size of the battery pack 16 may be provided. The battery pack 16 has a housing that is used to secure battery modules therein.

A first example for mounting the battery pack 16 is illustrated. Cross-members 36 extend below the battery pack 16 and may be used to support the battery pack 16 with the mounts 20. End cross-member 38 is positioned above the mounts 20. That is, each side of the cross-members 36 are coupled to the frame 12 through the supports 40. Removable fasteners 42 may be used to couple the frame 12 to the supports 40 so that the battery pack 16 can be removed. The mounts 20 are positioned to soften the mounting between the cross-members 36, 38 and the battery pack 16. This allows the battery pack 16 to be used as a dynamic absorber to address ride comfort problems.

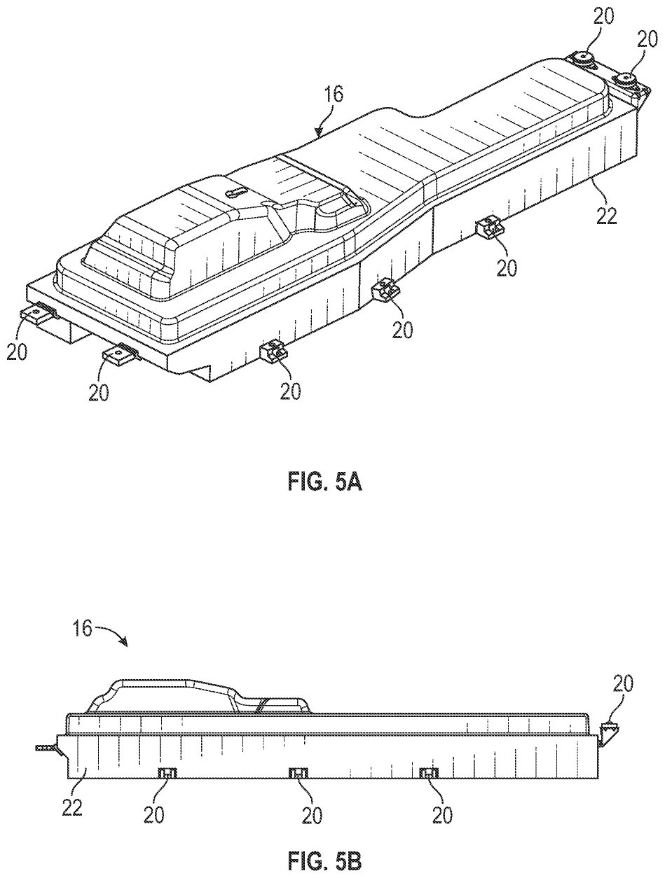

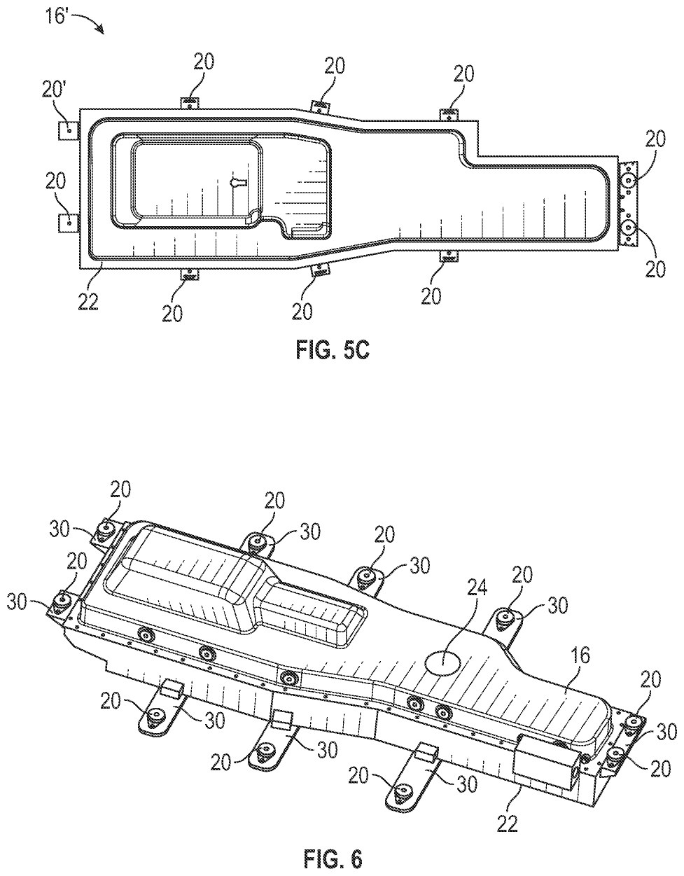

Referring now to FIGS. 4A-4F and FIGS. 5A-C, alternate views of the battery pack 16 from FIGS. 3A-3C are set forth with the frame. Various components are provided so the connecting method is clearly shown. A perspective view, side view and top view of the configuration for mounting the battery pack 16 and housing 22 are shown, respectively.

The mounts 20 have stiffness characteristics that may be tuned based upon the composition of materials used. For example, mounts 20 may be elastomeric mounts made of natural rubber. The stiffness characteristics of the natural rubber can be changed chemically or geometric parameters or combination thereof. Hydraulic mounts or active mounts may also be used. The amount of tuning required depends upon the characteristics and functional requirements of the vehicle 10.

In an alternate example, FIG. 6 shows arms or cross-members 30 that extend from the bottom of the battery pack 16. The arms or cross-members in this example may be integrally formed with the battery pack 16. The mounts 20 are disposed between the arms or cross-members 30 and the underside of the frame 12, so that the battery pack 16 along with the cross-members is softly mounted to the frame 12.

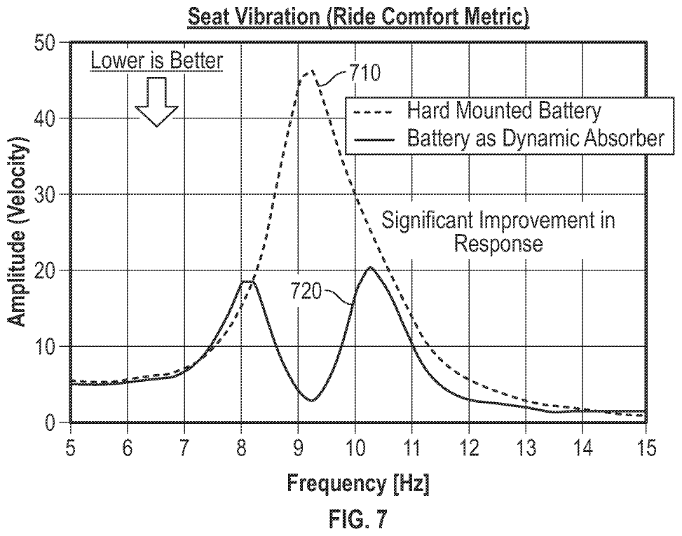

Referring now to FIG. 7, a plot of ride comfort metric (amplitude) versus frequency is set forth. The line 710 corresponds to a battery that is hard mounted to the frame. The line 7620 shows a battery pack 16 that acts as a dynamic absorber using soft mounts. The dynamic absorber splits the dominant peak into two lower amplitude peaks, which results in better performance for ride comfort. That is, the dynamic absorber counteracts or attenuates the response as compared to a hard mounted battery.

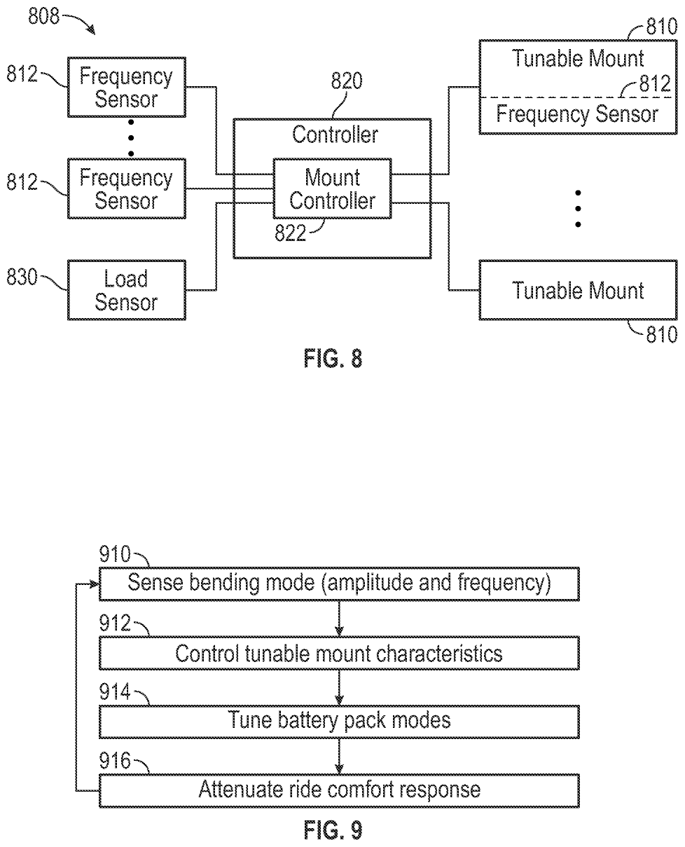

Referring now to FIG. 8, a control system 808 for controlling tunable mounts 810 is set forth. The tunable mounts 810 may have a frequency sensor 812 coupled thereto and a mechanism for changing the mount characteristics. However, the frequency sensors 812 may be located in various locations of the frame. The frequency sensors 812 generate signals corresponding to the amplitudes and the frequencies sensed. In this example, all the mounts may be tunable, and all the mounts may have frequency sensors 812. The frequency sensors 812 communicate with a controller 820 that has a mount controller 822 therein. The mount controller 822 is used to control the mount characteristics with an actuator that is provided within the tunable mount 810. All of the tunable mounts 810 may be controlled in the same manner. By providing the frequency sensors 812, the response of the frame may vary depending upon various operating conditions of the vehicle such as the amount of load and road inputs. However, a load sensor 830 may also be used to control the tunable mounts 810. Based upon an amount of load, the mount controller 822 may control the attenuating frequencies of the tunable mounts 810. The load sensor 830 may correspond to a ride height sensor which, in turn, is used to determine the amount of load within the vehicle. As the load changes, the frame modes may change and therefore the amplitudes controlled by the tunable mounts 810 may also be changed.

Referring to FIG. 9, a method of operating the system of FIG. 8 is set forth. In step 910, the bending mode amplitudes and frequencies may be sensed by the frequency sensors 812. In step 912, the mount controller 822 may determine the required characteristics for the tunable mounts and therefore the controller 820 tunes the battery pack modes in step 914. Therefore, during operation of the vehicle, the ride comfort response is attenuated in step 916.

In operation, the tunable mounts may be controlled together or individually. That is, different amplitudes of the ride comfort frequencies may appear at different sides or individual locations of the vehicle. One or more sensors may be distributed on the vehicle or on each mount. Therefore, the plurality of frequency sensors located at different points of the vehicle may measure the different frequencies and amplitudes associated therewith. The individual tunable mounts may be tuned to correspond to the frequencies sensed locally at the frequency sensors. That is, the amplitude of the frame response may be controlled by the tunable mounts to control the localized mode shapes.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a frame having a natural frequency;
a battery;
a battery housing having the battery disposed therein; and
a plurality of mounts coupling the battery housing to the frame, said plurality of mounts tuned to attenuate a ride comfort response of the frame.

2. The vehicle of claim 1 further comprising a vehicle body coupled on the frame.

3. The vehicle of claim 1 wherein the plurality of mounts comprises elastomeric mounts.

4. The vehicle of claim 1 wherein the plurality of mounts comprises hydraulic mounts.

5. The vehicle of claim 1 wherein the natural frequency comprises a primary, secondary, or higher order frame mode.

6. The vehicle of claim 1 further comprising a plurality of cross-members coupled to the frame, and wherein the cross-members couple to the battery housing through the plurality of mounts.

7. The vehicle of claim 6 wherein the plurality of cross-members is coupled to the frame with a plurality of supports.

8. The vehicle of claim 7 wherein said plurality of supports are coupled to the frame with removable fasteners.

9. The vehicle of claim 7 wherein at least one of the plurality of cross-members is positioned above at least one of the plurality of mounts.

10. The vehicle of claim 1 further comprising arms coupled to the battery housing coupled to the plurality of mounts.

11. The vehicle of claim 10 wherein the arms are integrally formed with the battery housing.

12. The vehicle of claim 10 wherein the plurality of mounts is disposed between the arms and the frame.

13. A control system comprising:
the vehicle of claim 1; and
a frequency sensor determining a natural frequency of the frame;
wherein the plurality of mounts comprises a plurality of tunable mounts; and
a controller controlling a frequency of the battery pack based on the natural frequency to attenuate the response.

14. The control system of claim 13 wherein the vehicle comprises a body-on-frame vehicle.

15. A method operating a vehicle comprising a frame having a natural frequency comprising:
forming a dynamic absorber from a battery housing by tuning a plurality of mounts to attenuate a response; and
coupling the battery housing to the frame with the plurality of tunable mounts.

16. The method of claim 15 further coupling a vehicle body to the frame.

17. The method of claim 15 wherein the natural frequency comprises a primary, secondary, or higher order frame mode.
